(19) United States
(12) Patent Application Publication
(10) Pub. No.: US 2024/0021020 A1
(43) Pub. Date: Jan. 18, 2024

(54) Methods and Systems for Secure Face Liveness Detection

(71) Applicant: Subex Assurance LLP, Bangalore (IN)

(72) Inventors: Shashank Shekhar, Bangalore (IN); Asif Salim, Kerala (IN); Mrinal Haloi, Nalbari (IN); Avinash Patel, Maharajganj (IN)

(21) Appl. No.: 18/046,474

(22) Filed: Oct. 13, 2022

(30) Foreign Application Priority Data
Jul. 12, 2022 (IN) 202241039893

(51) Int. Cl. G06V 40/40; H04N 7/18; G06V 40/60; G06V 20/40; G06V 40/16; G06V 10/82; G06V 40/20; G06V 40/18

(52) U.S. Cl. CPC G06V 40/40; H04N 7/183; G06V 40/67; G06V 20/41; G06V 40/171; G06V 10/82; G06V 40/20; G06V 40/193

(57) ABSTRACT

The principal object of embodiments herein is to disclose methods and systems for a secure and user-friendly face liveness detection. Another object of embodiments herein is to disclose a two layered approach for the face liveness detection, wherein the two-layered approach comprises an active and a passive face liveness detection.

### TECHNICAL FIELD

Embodiments disclosed herein relate to face recognition in biometrics, and more particularly to secure and user-friendly face liveness detection.

### BACKGROUND

Face liveness detection (FLD) is the ability of a computer system to detect if the person in front of the camera is alive and real. Face liveness detection is one of the key steps involved in user identity verification of customers during instances, such as online onboarding, transaction processes, and the like. During identity verification of the user, an unauthenticated user can bypass a verification system by various means. For example, the user can capture a photo from social media sources and can involve in an imposter attack using the printouts of the user's face. Imposter attacks could also be done by using a digital photo from a mobile device, or a sophisticated attack such as a video replay attack. Further, a user can wear a mask to pose as another individual.

Current techniques require a user's face to be irradiated with extra light source, or dynamic illumination in display screen. Further, existing techniques are computationally heavy as they require heavy hardware resources, such as an extra light source, a high resolution camera, sensors, specialized display, and multiple cameras. Therefore, the existing techniques for face liveness detection create user friction, and are not robust against all types of attacks. User friction refers to the activity a certain system demands the users to do, as a part of the system's solution, or the inconvenience caused to the user due to extra hardware. In certain current techniques, users may be required to track a moving object on a screen for collecting data of eye-ball rotation. Further, certain existing techniques require the users to read a random word that is displayed on a screen. In view of the above, a robust and a simple face liveness detection technique is required which would enable less user friction and also reduce the computational resources used in the current techniques.

### OBJECTS

The principal object of embodiments herein is to disclose methods and systems for a secure and user-friendly face liveness detection. The methods and systems disclosed herein utilize a two-layered approach for the face liveness detection. The two-layered approach comprises an active and a passive face liveness detection.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

Embodiments herein are illustrated in the accompanying drawings, through out which like reference letters indicate corresponding parts in the various figures. The embodiments herein will be better understood from the following description with reference to the drawings, in which:

FIG. 1 illustrates a system for face liveness detection, according to embodiments as disclosed herein;

FIG. 2 illustrates a workflow diagram depicting the method steps involved in the face liveness detection, according to embodiments as disclosed herein;

FIG. 3a illustrates the flowchart depicting the method steps involved in the verification of head rotation in left direction in the active liveness process, according to embodiments as disclosed herein;

FIG. 3b illustrates the flowchart depicting the method steps involved in the verification of head rotation in right direction in the active liveness process, according to embodiments as disclosed herein;

FIG. 4a illustrates a block diagram showing components of the active liveness module that perform 3D analysis of face structure, according to the embodiments herein;

FIG. 4b illustrates a 3D face geometry, according to the embodiments disclosed herein;

FIG. 4c illustrates a 2D projection of a nose tip point used for nose trajectory analysis, according to the embodiments herein;

FIG. 5a shows a block diagram of the components of the passive liveness detection module, according to the embodiments herein;

FIG. 5b illustrates the CNN architecture used by the passive liveness detection module, according to the embodiments herein;

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

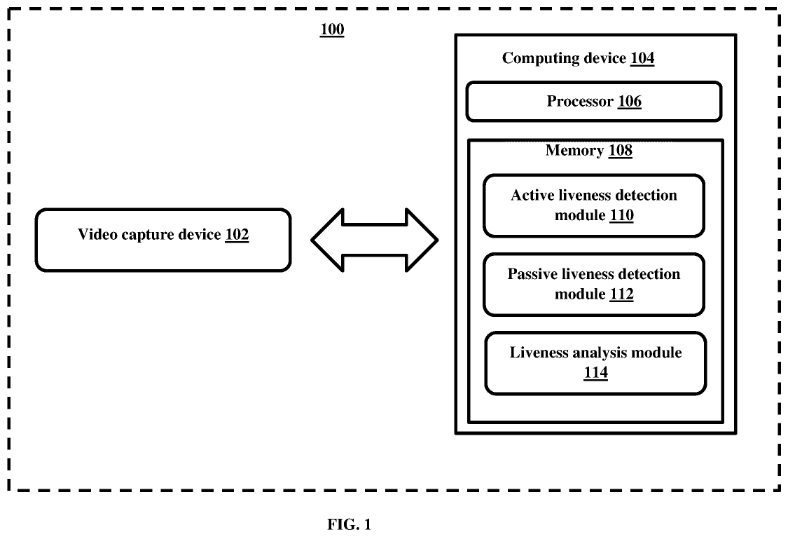

The embodiments herein provide a secure and user-friendly solution for face liveness detection. Embodiments herein provide robust techniques for detecting face liveness in varied lighting conditions and taking into account, different conditions associated with users, such as users belonging to different ethnicity, users wearing glasses, and the like. Embodiments herein discloses solutions for face liveness detection taking into account a wide range of face spoofing attacks by passive and active liveness solutions. Referring now to the drawings, and more particularly to FIGS. 1 through 5b, where similar reference characters denote corresponding features consistently throughout the figures, there are shown embodiments.

FIG. 1 illustrates a system 100 for face liveness detection, according to the embodiments as disclosed herein. The system 100 comprises a video capture device 102 communicatively coupled to a computing device 104 through a communication interface (not shown). The computing device 104 may be, for example, but not limited to, a laptop, a personal digital assistant, a smartphone, a desktop computer, and the like. The communication interface can use either wired, or wireless communication protocol. The communication interface enables transfer of the video captured by the video capture device 102 to the computing device 104. The video capture device 102 may comprise, for example, but not limited to, a camera, a video camera, and/or one or more other optical sensors. The video capture device 102 may comprise one or more sensors for enhancing the quality of videos captured by the video capture device 102. The video capture device 102 may be configured for continuous operation, or for periodic operation, or for on-command operation. Under the control of the processor 106, the video capture device 102 may provide a continuous video feed to the computing device 104 for face liveness detection. The computing device 104 is configured to perform face liveness detection. The computing device 104 comprises a processor 106 and a memory 108 coupled to the processor 106. The memory 108 may comprise volatile or non-volatile memory. The memory 108 comprises one or more modules, such as an active liveness detection module 110 and a passive liveness detection module 112 that comprise instructions for causing the processor 106 to detect face liveness from the video which is input to the computing device 104.

Embodiments herein provide a user-friendly detection system without compromising security. Embodiments herein disclose a two layered solution comprising the active and passive liveness detection modules.

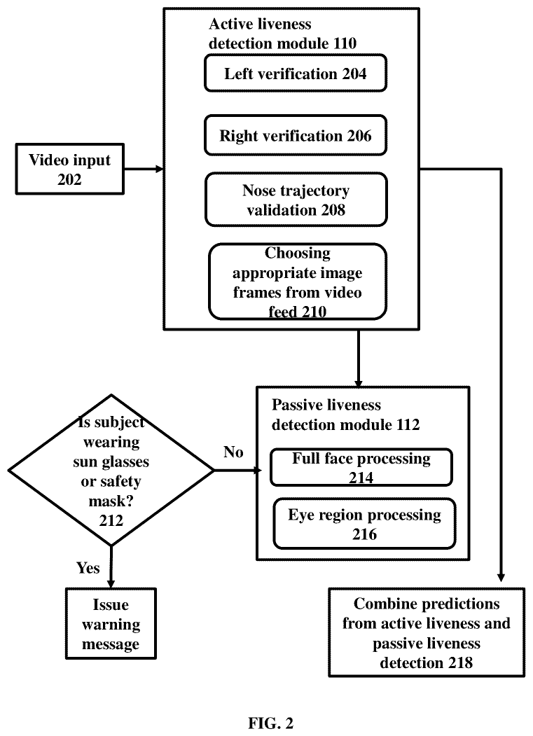

FIG. 2 illustrates a workflow diagram depicting the method steps involved in the face liveness detection, according to the embodiments disclosed herein. At step 202, a video sequence of a user is captured by the video capture device 102 which is input to the computing device 104. The user can be, for example, a live user, a spoofer, an attacker, an imposter, a 2D photograph, and the like. The video capture device 102 captures the video sequence of the user as a sequence of frames of face video image of the user. The video capture device 102 may provide a continuous video feed to the computing device 104. The computing device 104 first initiates the operations of the active liveness module 110. On receiving the live video of the user or a subject, the active liveness module 110 displays instruction on the screen to prompt the user to rotate his/her head on right and left directions. The terms “user” and “subject” are used interchangeably hereinafter. At step 204, the active liveness detection module 110 performs left verification by checking whether the user's head is turned towards the left. At step 206, the active liveness module 110 performs right verification by checking whether the user's head is turned towards the right. The steps involved in the left verification and right verification are explained in detail below. At step 208, the active liveness module 110 performs nose trajectory validation for enhancing the security of left and the right verification processes. In the nose trajectory validation step, the active liveness module 110 analyzes the trajectory of the movement of the user's nose. At step 210, the processor selects the video image frames from the video sequence to be processed by the passive liveness detection module 112.

At step 212, the passive liveness detection module 112 processes the video image frames to check if the user is wearing a safety mask, or a sunglass. If not, the video image frames is passed to the passive liveness detection module 112. If the user is detected to be wearing either a sun glass, or a safety mask, the passive liveness detection module 112 displays a warning message. At step 214, the passive liveness detection module 112 performs full face liveness. For the full face processing, the passive liveness detection module 112 selects the video image frames corresponding to yaw angle close to zero from the input video sequence. In the full face liveness, face of the user and background region surrounding the face is input to a CNN to predict if the user is bonafide one or an attacker. At step 216, the passive liveness performs eye region processing. In the eye region processing, the region around eyes of the user is input to a CNN to predict if the user is bonafide one or an attacker. For eye region processing, the passive liveness detection module 112 selects the video image frames corresponding to a large variation of yaw angle from the input video sequence 202. At step 218, a liveness analysis module 114 combines the prediction from the active liveness detection module 110 and the passive liveness detection module 112 to make the final decision whether the user is bonafide or an attacker using face spoofing techniques. The active liveness and the passive liveness detections will be discussed in detail below.

The video capture device 102 feeds the live video sequence comprising the plurality of face video image frames to the active liveness detection module 110. On receiving the live video sequence of the user, the active liveness detection module 110 displays instructions on the screen of the computing device 104 to prompt the user to rotate his/her head on right and left directions. The prompt instructions may be displayed in the form of one of a demo and a text message. The prompt instructions prompts the user to complete the necessary actions within a pre-determined time period, for example, but not limited to, 5 seconds. The active liveness module 110 performs left verification by checking whether the user's head is turned towards the left and performs right verification by checking whether the user's head is turned towards the right. For verifying whether the user has turned towards left or right direction, the active liveness module 110 computes the yaw angle value. Yaw angle gives the degree of the rotation of a head about a vertical axis.

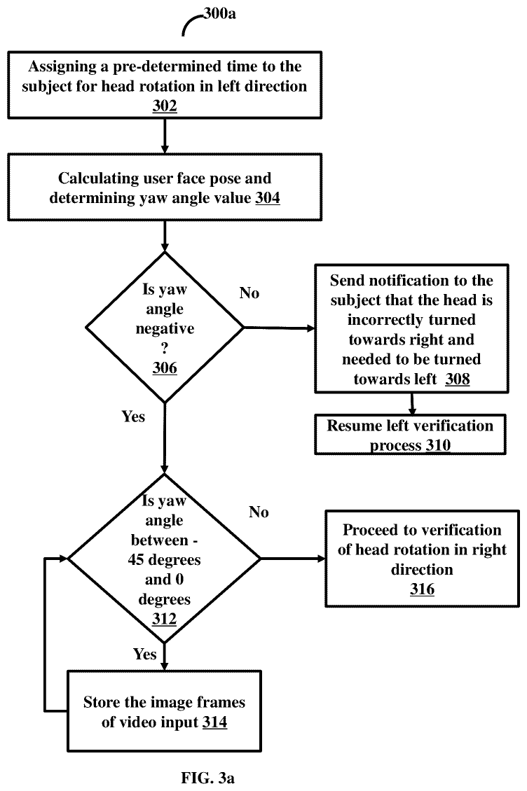

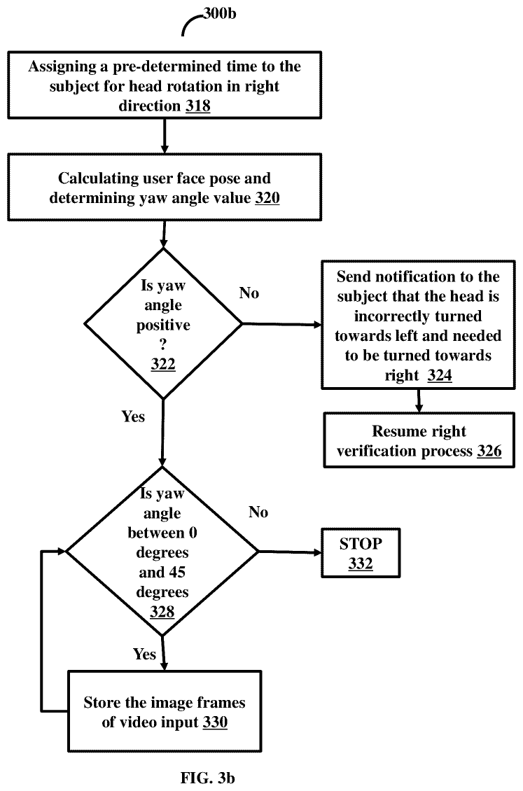

FIG. 3a illustrates the flowchart depicting the method steps 300a involved in the verification of head rotation in left direction in the active liveness detection process, according to the embodiments herein. At step 302, the active liveness detection module 110 assigns a pre-determined time, for example, but not limited to, 5 seconds, for rotating the head in left direction. To prompt the user to turn his/her head in the left direction, the active liveness detection module 110 displays one of a message to the user and a demo, to prompt the user to turn towards the left direction. The active liveness detection module 110 uploads the face video image frames at a pre-determined time duration, for example, but not limited to, 0.02 second, to a server until the face video image frames reach 45 degree angle in the left direction. At step 304, the active liveness detection module 110 calculates the user face pose and determines the yaw angle value. At step 306, the active liveness detection module 110 determines if the yaw angle is negative. On determining that the yaw angle is not negative, but positive, at step 308, the active liveness detection module 110 sends a notification to the user that the user has turned his/her head incorrectly in the right direction and that the user is required to turn head towards left. As a result at step 310, the left verification process resumes. On determining that the yaw angle is negative, at step 312, the active liveness detection module 110 continuously checks if the yaw angle is between −45 degrees and 0 degree. If this condition is satisfied, at step 314, the active liveness detection module 110 stores the corresponding face video image frames from the video capture device 102 in the memory 108. When the yaw angle is less than −45 degrees, the left verification is stopped, and at step 316, the processor 106 initiates the right verification.

FIG. 3b illustrates the flowchart depicting the method steps 300b involved in the verification of head rotation in right direction in the active liveness detection process, according to the embodiments herein. At step 318, the active liveness detection module 110 assigns a pre-determined time, for example, but not limited to, 5 seconds, for the user to turn his/her head in the right hand side direction. At step 320, the active liveness detection module 110 calculates the user face pose and determines the yaw angle value. At step 322, the active liveness detection module 110 determines if the yaw angle is positive. If the yaw angle is not positive but negative, at step 324, the active liveness detection module 110 sends a notification to the user that the user has turned his/head incorrectly in the left direction and that the user has to turn the head towards right. As a result at step 326, the right verification process resumes. At step 328, the active liveness detection module 110 determines if the yaw angle is between 0 degree and 45 degree. If this condition is satisfied, at step 330, the active liveness detection module 110 stores the corresponding face video image frames from the video capture device 102 in the memory. At step 332, if the yaw angle is greater than 45 degrees, the active liveness detection module 110 stops the liveness test.

The various actions in method steps shown in FIG. 3a and FIG. 3b may be performed in the order presented, in a different order or simultaneously. Further, in some embodiments, some actions listed in FIG. 3a and FIG. 3b may be omitted.

On completing the verification of head rotation in the left and right directions, the active liveness detection module 110 samples face video image frames of both left and right direction head rotations separately. The active liveness detection module 110 uses 3D analysis of face structure for further computations that reinforce security.

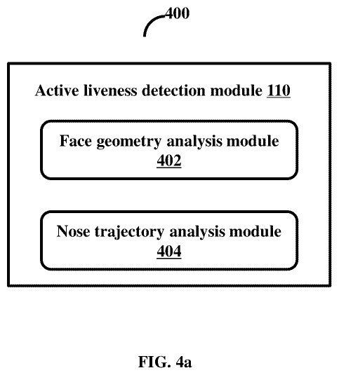

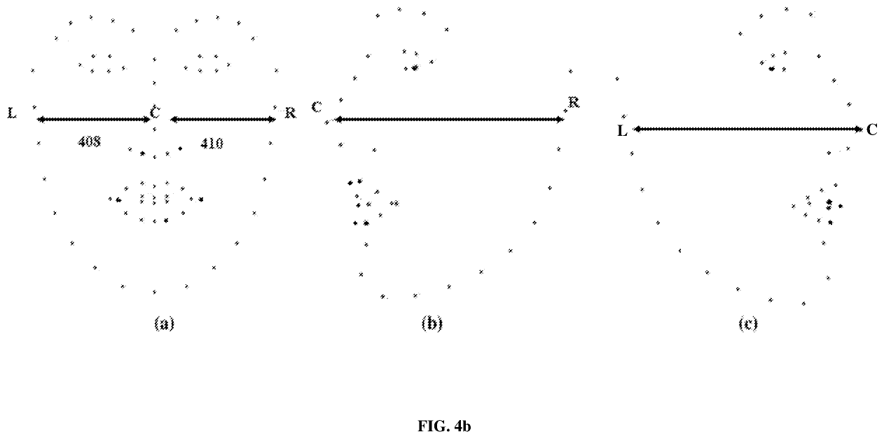

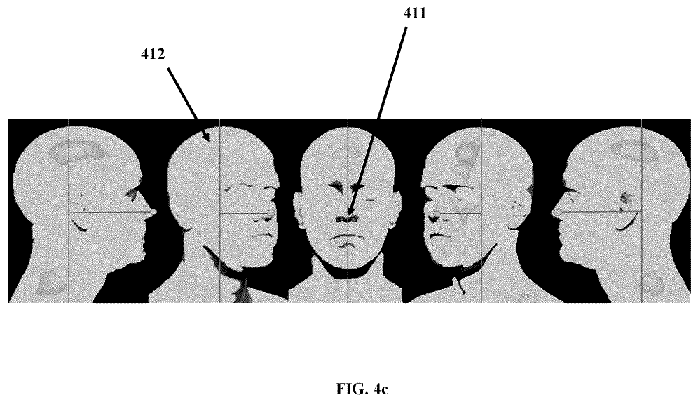

FIG. 4a illustrates a block diagram 400 showing components of the active liveness detection module 110 that perform 3D analysis of face structure, according to the embodiments herein. The active liveness detection module 110 comprises a face geometry analysis module 402 and a nose trajectory analysis module 404.

FIG. 4b illustrates a 3D face geometry 406, according to the embodiments disclosed herein. The 3D face geometry shows the face landmarks of the user when he/she faces the camera. The face geometry analysis is based on the assumption that, for a live user, the face landmarks adhere to the 3D face geometry as shown in the FIG. 4b. The face geometry analysis module 402 uses the following information in the face landmarks for the geometry analysis. Point C corresponds to a center region of the face on the nose. Point L corresponds to the left most region of the face around the left ear. Point R corresponds to the right most region of the face around the right ear. D_left 408 is the distance between the point C and point L. D_right 410 is the distance between point C and point R.

As the head is rotated either way, the positions of points C, L, and R and therefore the ratio of D_left 408 to D_right 410 change their values. The ratio of D_left 408 to D_right 410 is defined as left rotation ratio and the ratio of D_right 410 to D_left 408 is defined as right rotation ratio. A 2D projection of point L comes close to point C and the 2D projection of point R gets further away from point C, when the user rotates his/her head in left direction at more than 45 degrees, and vice versa. It is to be noted that, in case of a face printed on a 2D surface, such as photograph, the 2D projection of point L and point R are in the same relative distance at all angles of head rotation. The face landmarks 2D projection-based feature is defined as below:

Left rotation ratio=D_left/D_right

Right rotation ratio=D_right/D_left

In case of the left hand side head rotation task, the face geometry analysis module 402 computes and stores the left rotation ratio in all the face video image frames obtained from the live video sequence of the video captured by the video capture device 102. For a 3D face, minimum among all the left rotation ratios should be almost zero. Similarly, in the case of right rotation task, the face geometry analysis module 402 computes and stores the right rotation ratio in all the face video image frames obtained from the live video sequence of the video captured by the video capture device 102. For a 3D face, minimum among all the right rotation ratios should be close to zero.

FIG. 4c illustrates a 2D projection of a nose tip point 411 used for nose trajectory analysis, according to the embodiments herein. The nose trajectory analysis module performs the nose trajectory analysis for enhancing the security of the liveness detection further. The nose trajectory analysis module processes the same data, i.e., the sequence of the face video frames captured by the video capture device 102, that has been used for the left and right head rotation tasks. As shown in FIG. 4c, for a 3D human face, a vertical axis of rotation 412 passes through the neck. Further, the nose tip point 411 that can be derived from the face landmarks lie at a horizontal distance of about 10 cm from bottom of the vertical axis. When a live user rotates his/her head in one of left and right directions, the nose tip point 411 traverses in the form of an arc of certain radius, say about 10 cm. This arc is referred to as the nose trajectory.

As shown in FIG. 4c, for a live user's face presented as 3D, the projection always lies at a distance from the vertical axis of rotation 412. In contrast, for a 2D face printed on a 2D surface, the nose tip point 411 lies on the vertical axis of rotation 412 passing through the neck. In other words, if an attacker or an imposter presents a 2D photo, the nose tip remains in the axis of rotation during the head rotation task, or the 2D photo does not make an arc like the nose trajectory in the case of 3D. This is based on the assumption that there is no significant horizontal motion of the 2D photo.

The nose trajectory module 404 computes a horizontal length of the 2D projection of arc in the nose trajectory while the live user rotates his head in the left and right directions and defines this value as a nose trajectory length. The nose trajectory length is computed as:

Nose trajectory length=length of the 2D projection of the 3D nose trajectory into a vertical plane

The face dimensions of the live subject can vary in a large range. To render the nose trajectory length scale invariant, the nose trajectory analysis module 404 computes an inter pupillary distance (IPD) of the user's eyes from the frame where the user is looking straight-up, i.e., at an yaw angle of 0 degrees. The nose trajectory analysis module 404 computes a normalized nose trajectory length to enable scale invariance as following: Normalized nose trajectory length=Nose trajectory length/IPD

To classify a 3D face from a 2D face using the normalized nose trajectory length, the nose trajectory module uses a threshold value based on empirical results.

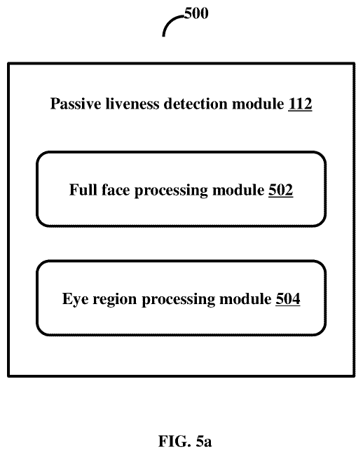

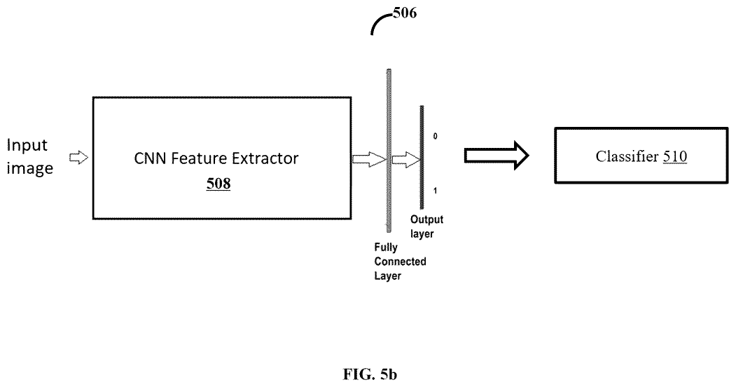

FIG. 5a shows a block diagram 500 of the components of the passive liveness detection module 112, according to the embodiments herein. The passive liveness detection module 112 comprises a full face processing module 502 and an eye region processing module 504. The passive liveness detection module 112 detects whether the subject is wearing a safety mask, or a sun glass, by training a lightweight convolutional neural network (CNN). If the user is wearing either a safety mask, or a sun glass, the passive liveness detection module 112 is configured to display a message to remove the safety mask, or the sun glass that the user is wearing. The passive liveness detection module 112 is designed as an ensemble model that contains lightweight CNNs that have been trained for full face detection and eye detection performed by the full face processing module 502 and the eye region processing module 504, respectively. The full face processing module 502 and the eye region processing module 504 are trained as a binary classification network to classify whether the user is bonafide, or an imposter. The full face processing module 502 and the eye region processing module 504 each use custom CNN architecture for feature extraction and fully connected dense layers for the classification. With this ensemble CNN model, the face spoofing attacks can be easily identified by identifying the anomalies.

The user is assigned as bonafide based on the logical AND operation over the output given by the individual models. That is, in the case of the passive liveness module 112, the user is assigned as bonafide if both the full face processing module 502 and the eye region processing module 504 predict the user as bonafide. If one among the full face processing module 502 and the eye region processing module 504 predicts the user as an attacker, or both of the modules predict the user as an attacker, then the passive module assigns the user as an attacker. In the case of active liveness module, the user is assigned as bonafide if all among the left verification 204, right verification 206, and nose trajectory validation assigns the user as bonafide. If one among these validation steps assigns the user as an attacker or all assigns the user as an attacker, then the active liveness module assigns the user as an attacker. The final decision about the user is assigned by combining the results from both the active liveness module 110 and passive liveness module 112 through a logical AND operation. That is, the user is assigned as bonafide if both the active liveness module 110 and passive liveness module 112 predict the user as bonafide. If one among the active liveness module 110 and the passive liveness module 112 predicts the user as an attacker, or both of the modules predict the user as an attacker, then the entire liveness solution assigns the user as an attacker.

The full face processing module 502 performs the full face detection along with background region, i.e., face liveness verification. The full face processing module 502 analyzes various attributes in pixels of a digital image. The full face processing module 502 identifies the real users from attackers or imposters by analyzing a background region. The full face processing module 502 uses a classification model that combines background region with user face region.

The eye region processing module 504 detects the eye region of the user from the video input. Eye region comprises more robust features than any other part of the user's face which is hard for the attacker or an imposter by any means. The eye region processing module 504 uses a deep neural network to identify the user's eye region. The deep neural network which is a custom CNN architecture is trained and a training data is developed for this. The training data comprises images corresponding to attacking or spoofing cases and also the bonafide or authentic cases. The eye region processing module 504 uses a classification model to distinguish the real user from spoofing cases. The classification model obtains features of the eyes of the user from the sequence of video frames as input and classifies whether the user is real, or an attacker, based on the training data.

FIG. 5b illustrates the CNN architecture 506 used by the passive liveness detection module 112, according to the embodiments herein. The CNN architecture 506 is a CNN based image classification system consisting of two components namely a feature extractor 508 and a classifier 510. The feature extractor 508 uses different kernels or filters for identifying and extracting features from the video image frames. As explained above, the features are related to the eye region and the face of the user. The feature extractor 508 learns weights of the kernels while training the model on a training data set. The classifier 510 receives the extracted features as input and classifies the extracted features.

Embodiments herein can be embedded in a computing device, such as, but not limited to a smart phone, for example, in an android application and can be deployed in electronic devices with a camera sensor. Embodiments herein create a user-friendly face liveness detection system that provides maximum security.

Embodiments herein can be utilized for face liveness detection under various conditions, such as with different light conditions, different ethnicities, and attacking scenarios.

Embodiments herein can be used for online customer boarding or customer verification applications that require a secure, user-friendly, and an efficient customer face verification. Embodiments herein provide a secure technique thereby providing protection against attacking cases of printed photo, mobile photo, 3D paper mask, and video replay. Embodiments herein results in the least user friction as the users are only required to rotate their heads in the left and right directions, thereby significantly reducing the time taken for the entire verification process. Embodiments herein provide an efficient technique in terms of computation load, hardware requirements, and runtime and therefore can be deployed as an application in user systems, or the same can be served as a REST API.

The embodiments disclosed herein can be implemented through at least one software program running on at least one hardware device and performing network management functions to control the network elements. The network elements shown in FIG. 1 include blocks which can be at least one of a hardware device, or a combination of hardware device and software module.

The embodiment disclosed herein describes a secure and user-friendly technique for face liveness detection. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g. Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the spirit and scope of the embodiments as described herein.

1. A method for detecting face liveness, the method performed by a computing device, the method comprising:
receiving, by an active liveness detection module of the computing device, a video input from a video capture device, wherein the video input comprises a sequence of video image frames of a user captured by the video capture device;
verifying, by the active liveness detection module, head rotation in left direction and right direction, of the user present in the video input;
sampling, by the active liveness detection module, the sequence of video image frames corresponding to the head rotation in the left and right directions and performing a 3D analysis of a face structure of the user;
validating, by the active liveness detection module, a nose trajectory of the user;
receiving, by a passive liveness detection module, from the active liveness detection module, the sequence of video image frames for eye region processing and full-face processing;
performing, by the passive liveness detection module, the eye region processing and the full-face processing; and
providing, by a liveness analysis module, liveness result by combining results from the active liveness detection module and the passive liveness detection module.

2. The method as claimed in claim 1, wherein verifying the head rotation in left direction comprises:
prompting, by the active liveness detection module, the user to turn the head in left direction within a pre-determined time duration;
uploading, by the active liveness detection module, the sequence of the video image frames to an external server until sequence of the video image frames reaches an angle of 45 degrees in the left direction;
calculating, by the active liveness detection module, a face pose of the user and determining a yaw angle value;
determining, by the active liveness detection module, if the yaw angle is negative;
sending, by the active liveness detection module, a notification to the user, that the head is incorrectly turned towards right and that the user has to turn the head towards left, if the yaw angle is positive;
on determining that the yaw angle is negative, determining, by the active liveness detection module if the yaw angle is between −45 degrees and 0 degrees;
on determining that the yaw angle is between −45 degrees and 0 degrees, storing, by the active liveness detection module, the sequence of video image frames; and
proceeding, by the active liveness detection module, with the verification of head rotation in the right direction, if the yaw angle is lesser than −45 degrees.

3. The method as claimed in claim 1, wherein verifying the head rotation in the right direction comprises:
prompting, by the active liveness detection module, the user to turn the head in the right direction within a pre-determined time duration;
uploading, by the active liveness detection module, the sequence of the video image frames to an external server until the sequence of the video image frames reaches an angle of 45 degrees in the right direction;
calculating, by the active liveness detection module, a face pose of the user and determining a yaw angle value;
determining, by the active liveness detection module, if the yaw angle is positive;
sending, by the active liveness detection module, a notification to the user, that the head is incorrectly turned towards left and that the user has to turn the head towards right, if the yaw angle is negative;
on determining that the yaw angle is positive, determining, by the active liveness detection module, if the yaw angle is between 0 degrees and 45 degrees;
on determining that the yaw angle is between 0 degrees and 45 degrees, storing, by the active liveness detection module, the sequence of the video image frames; and
on determining that the yaw angle is not lesser than 45 degrees, stopping, by the active liveness detection module, the liveness detection.

4. The method as claimed in claim 1, wherein performing the 3D analysis of the face structure of the user comprises:
computing a left side distance, wherein the left side distance comprises a distance between a center region of the face on the nose and a left most region of the face around left ear of the user;
computing a right side distance, wherein the right side distance comprises a distance between the center region of the face on the nose and a right most region of the face around right ear of the user; and
calculating a face landmarks 2D projection-based feature, wherein the face landmarks 2D projection-based feature corresponds to a left rotation ratio and a right rotation ratio, wherein the left rotation ratio is the ratio of the left side distance to the right side distance, and wherein the right rotation ratio is the ratio of the right side distance to the left side distance.

5. The method as claimed in claim 1, wherein validating the nose trajectory of the user comprises computing a 2D projection of a nose tip point of the user by calculating a nose trajectory length, wherein the nose trajectory length is a length of a 2D projection of a 3D nose trajectory into a vertical plane.

6. The method as claimed in claim 1, wherein performing, by the passive liveness detection module, the full face processing, comprises:
analyzing a plurality of attributes in pixels of the sequence of video image frames;
identifying live users by analyzing a background region of the sequence of video image frames; and
using a classification model for combining the background region and region comprising the face of the user.

7. The method as claimed in claim 1, wherein performing, by the passive liveness detection module, the eye region processing, comprises detecting the eye region of the user from the video input by using a deep neural network and classifying as one of real user and an attacker using a classification model.

8. A computing device for detecting face liveness, wherein the computing device comprises:
a processor; and
a memory coupled to a processor, wherein the memory comprises an active liveness detection module, a passive liveness detection module, and a liveness analysis module, wherein the active liveness detection module is to:
receive a video input from a video capture device, wherein the video input comprises a sequence of video image frames of a user captured by the video capture device;
verify head rotation in left direction and right direction, of the user present in the video input;
sample the sequence of the video image frames corresponding to the head rotation in the left and right directions and perform a 3D analysis of a face structure of the user; and
validate a nose trajectory of the user;
wherein the passive liveness detection module is to:
receive from the active liveness detection module, the sequence of the video image frames for eye region processing and full-face processing; and
perform the eye region processing and the full-face processing; and
wherein a liveness analysis module is to:
provide liveness result by combining results from the active liveness detection module and the passive liveness detection module.

9. The computing device as claimed in claim 8, wherein the active liveness detection module is to verify the head rotation in left direction by:
prompting the user to turn the head in the left direction within a pre-determined time duration;
uploading the sequence of the video image frames to an external server until the sequence of the video image frames reaches an angle of 45 degrees in the left direction;
calculating a face pose of the user and determining a yaw angle value;
determining if the yaw angle is negative;
sending a notification to the user that the head is incorrectly turned towards right and that the user has to turn the head towards left, if the yaw angle is positive;
determining if the yaw angle is between −45 degrees and 0 degrees, on determining that the yaw angle is negative;
storing the sequence of the video image frames, on determining that the yaw angle is greater than −45 degrees; and
proceeding with the verification of head rotation in the right direction, if the yaw angle is lesser than −45 degrees.

10. The computing device as claimed in claim 8, wherein the active liveness detection module is to verify the head rotation in right direction by:
prompting the user to turn the head in the right direction within a pre-determined time duration;
uploading the sequence of the video image frames to an external server until the sequence of the video image frames reaches an angle of 45 degrees in the right direction;
calculating a face pose of the user and determining a yaw angle value;
determining if the yaw angle is positive;
sending a notification to the user, that the head is incorrectly turned towards left and that the user has to turn the head towards right, if the yaw angle is negative;
determining if the yaw angle is between 0 degrees and 45 degrees, on determining that the yaw angle is positive;
storing the sequence of the video image frames, on determining that the yaw angle is lesser than 45 degrees; and
stopping, by the active liveness detection module, the liveness detection, on determining that the yaw angle is not lesser than 45 degrees.

11. The computing device as claimed in claim 8, wherein the active liveness detection module is to perform the 3D analysis of the face structure of the user by:
computing a left side distance, wherein the left side distance comprises a distance between a center region of the face on the nose and a left most region of the face around left ear of the user;
computing a right side distance, wherein the right side distance comprises a distance between the center region of the face on the nose and right most region of the face around right ear of the user; and
calculating a face landmarks 2D projection-based feature, wherein the face landmarks 2D projection-based feature corresponds to a left rotation ratio and a right rotation ratio, wherein the left rotation ratio is the ratio of the left side distance to the right side distance, and wherein the right rotation ratio is the ratio of the right side distance to the left side distance.

12. The computing device as claimed in claim 8, wherein the active liveness detection module is to validate the nose trajectory of the user by computing a 2D projection of a nose tip point of the user by calculating a nose trajectory length, wherein the nose trajectory length is a length of a 2D projection of a 3D nose trajectory into a vertical plane.

13. The computing device as claimed in claim 8, wherein the passive liveness detection module is to perform the full face processing by:
analyzing a plurality of attributes in pixels of the sequence of video image frames;
identifying live users by analyzing a background region of the sequence of video image frames; and
using a classification model for combining the background region and region comprising the face of the user.

14. The computing device as claimed in claim 8, wherein the passive liveness detection module is to perform the eye region processing by: detecting the eye region of the user from the sequence of video image frames by using a deep neural network and classifying as one of real user and an attacker using a classification model.

15. The computing device as claimed in claim 8, wherein the liveness analysis module is to assign a user as one of a real user and an attacker by using a logical AND operation from results of each of the active liveness detection module and the passive liveness detection module.
